(19) United States
(12) Patent Application Publication
(10) Pub. No.: US 2022/0204003 A1
(43) Pub. Date: Jun. 30, 2022

(54) Formal Verification for the Development and Real-Time Application of Autonomous Systems

(71) Applicant: Kontrol GmbH, Linz (AT)

(72) Inventor: Michael Naderhirn, Elkridge, MD (US)

(21) Appl. No.: 17/609,192

(22) PCT Filed: May 7, 2020
(86) PCT No.: PCT/AT2020/060184

§ 371 Date: Nov. 5, 2021

Related U.S. Application Data
(60) Provisional application No. 62/844,714, filed on May 7, 2019.

(51) Int. Cl. B60W 50/02; B60W 40/02; B60W 60/00; B60W 50/00; B60W 10/18; B60W 10/20

(52) U.S. Cl. CPC B60W 50/0205; B60W 40/02; B60W 60/001; B60W 50/0097; B60W 2555/60; B60W 10/20; B60W 2050/0029; B60W 2552/53; B60W 10/18

(57) ABSTRACT

One embodiment described herein relates to a method for supervising a dynamic system, for example a vehicle. The method includes receiving a system state sample and calculating, for a specific time instant, a reachable set of system states based on a current system state and a system model representing the dynamic system. The method further includes calculating a mathematical representation of a specific manifestation of a generic rule and calculating an allowed subset of system states based on the reachable set and the mathematical representation of the specific manifestation of the generic rule. Furthermore, the method includes testing whether the system state sample is within the allowed subset.

### TECHNICAL FIELD

The present disclosure relates to a formal verification method for autonomous systems (e.g. autonomous vehicle such as self-driving cars, unmanned aerial vehicles (UAVs), etc.) which may be applied in real-time (“online” during operation of the vehicle) and during the development process (“offline”) for checking whether the autonomous system complies with a predefined rule set.

### BACKGROUND

Today a lot of mechatronic systems are developed and sold without satisfying important safety standards. The reason for that fact is that the required cost and time effort to develop according to the applicable safety standards is relatively high. Therefore, only “high-end” applications like e. g. in the field of automotive and aeronautic industry rigorously applies this standards in the system design.

Depending on the application, mechatronic systems should be developed according to different safety standards such as, for example, ISO 26262 (titled: “Road vehicles—Functional safety”) in the field of automotive industry, IEC62061 (titled “Safety of machinery: Functional safety of electrical, electronic and programmable electronic control systems”) for safety of machines, EN51028 in the field of railway industry, or DO254/DO178C in the field of aeronautic industry in order to satisfy, e.g., the E.U. Machinery Directive. Most of them are derived from the meta-standard IEC 61508. In order to do that typically a so-called V-model is an accepted system development process applied in the system design (software and hardware design) according these standards.

In order to develop and design a system in accordance with the V-model a lot of development time is needed for testing, documentation and verification. As an illustrative example, the starting point of the workflow may be a textual specification of requirements. In the next step, a system software model is developed (e. g. using the common numerical computing environment Matlab/Simulink) which complies with the requirements specification. To prove compliance with the requirements specification a review is then done by an independent developer (four eye principle) in the case of low criticality or additional by a third party reviewer (six eye principle) in the case of high criticality of the system.

In order to decrease the development cost The Math Works, Inc. introduced several Matlab-based tools which allow for a partial automation of the development process. These tools include automatic code generation, automatic traceability of changes of the requirements in the models, automatic test design as well as verification and validation of the system design. Looking back to the V-model development cycle, these tools automate the lower part of the “V”, whereas the top levels of the V-Model still entail manual work which must be performed “manually” by engineers.

In addition to an efficient verification of an autonomous system during the development process, there is a need for a continuous checking and verification of the system behavior during operation of the autonomous system (e.g. the self-driving car or an UAV) in order to ensure the actual system behavior complies with a desired behavior specified by a predefined rule set (e.g. traffic rules).

### SUMMARY

One embodiment described herein relates to a method for supervising a dynamic system, for example a vehicle. The method includes receiving a system state sample and calculating, for a specific time instant, a reachable set of system states based on a current system state and a system model representing the dynamic system. The method further includes calculating a mathematical representation of a specific manifestation of a generic rule and calculating an allowed subset of system states based on the reachable set and the mathematical representation of the specific manifestation of the generic rule. Furthermore, the method includes testing whether the system state sample is within the allowed subset.

In one specific embodiment, the system state sample is predicted (pre-calculated) by a controller coupled to the dynamic system, wherein the predicted system state sample is part of a trajectory planned by the controller.

Another embodiment described herein relates to a control system. The system includes a dynamic system (e.g. a mechanical system such as a vehicle) and a digital controller coupled to the dynamic system to form a control loop. The control system further includes a monitor unit that is configured to: receive sensor data including information concerning the current system state of the dynamic system; calculate—for a specific time instant—a reachable set of system states based on the current system state and a system model; calculate a mathematical representation of a specific manifestation of a generic rule, wherein the specific manifestation is determined based on sensor data; and calculate an allowed subset of system states based on the reachable set and the mathematical representation of the specific manifestation of the generic rule. Furthermore, the control system includes a testing unit configured to receive a system state sample from the digital controller and to test whether the system state sample is within the allowed subset.

### BRIEF DESCRIPTION OF THE DRAWINGS

The invention can be better understood with reference to the following drawings and descriptions. The components in the figures are not necessarily to scale; instead emphasis is placed upon illustrating the principles of the invention. Moreover, in the figures, like reference numerals designate corresponding parts. In the drawings:

FIG. 1 is a diagram to visualize one example of a formal verification method.

FIG. 2 illustrates the data flow and functional blocks of one embodiment of a formal verification method used “offline” during the development process.

FIG. 3 is a diagram illustrating one example of the geometric implementation of features.

FIG. 4 is a diagram illustrating the data flow and setup of the development process.

FIG. 5 illustrates the usage of a Graphical User Interface (GUI) to convert a textual specification into digital data representing the system requirements

FIG. 6 illustrates the data flow and functional blocks of one embodiment of a real-time verification method.

FIG. 7 is an exemplary flow chart illustrating the generation of an emergency path.

FIG. 8 is an exemplary flow chart illustrating one exemplary embodiment of a method for supervising/monitoring a system described herein.

### DETAILED DESCRIPTION

One aspect of the embodiments described herein relates, first, to the calculation of a reachable set of system states, which are to be controlled and, second, to the calculation of a geometrical interpretation of the “features”, which an autonomous vehicle should follow or comply with including some information as to how the vehicle might violate a feature or not. This information is then used to assess whether, or not, a (e.g. simulated, predicted or measured) sample system state (resulting from a specific input to the system) is within the reachable set and does not violate the features. If positive, the sample system state (or the system input that causes the system state) is formally verified. As will be discussed in more detail further below, a feature can be regarded as a mathematical representation of a specific manifestation of a generic rule, which may be part of a textual specification (rule set) applicable to the system.

The above-mentioned reachable set may describe the set of system states (which may be interpreted, e.g., as an area, volume, or a higher-dimensional equivalent thereof) which a dynamical system is able to reach within a given time t. A 2D double integrator, which may be used as a simple model representing the dynamic behavior of an automobile, is considered as an illustrative example of a dynamic system for the following explanations. Assuming the system state is denoted as (x, v)^{T}, wherein x=(xₓ, x_{y})^{T} is a vector denoting a 2D position (e.g. of the car) and v=(vₓ, v_{y})^{T} is a vector denoting the corresponding 2D velocity (the superscript ‘T’ denoting the transpose operator). In this example, the system model can then be expressed by the following differential equation

$$\frac{d}{dt} ( \begin{matrix}x \\ v\end{matrix} ) = ( \begin{matrix}0 & 1 \\ 0 & 0\end{matrix} ) ( \begin{matrix}x \\ v\end{matrix} ) + ( \begin{matrix}0 \\ {a}_{0}\end{matrix} ) ,$$

wherein a₀=(a_{x,0}, a_{y,0})^{T} denotes the initial acceleration. The operator ‘d/dt’ denotes the time derivative. Assuming a constant acceleration a₀ (at least for a short integration time interval), the above equation yields

$$x = \frac{{a}_{0}}{2} {t}^{2} + {v}_{0} t + {x}_{0} ,$$

wherein v₀=(v_{x,0}, v_{y,0})^{T} denotes the initial velocity and x₀=(x_{x,0}, x_{y,0})^{T} denotes the initial position. It is noted that the system state may also be represented by position, scalar velocity and Euler angels (pitch, yaw and roll angles, wherein for 2D movement only the yaw angle is relevant).

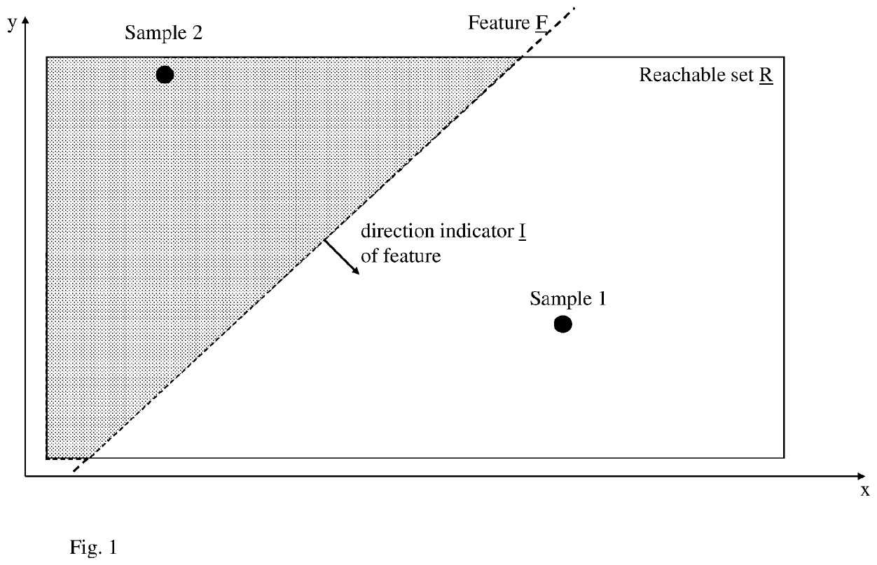

FIG. 1 illustrates, by way of example, the reachable set R for the 2D double integrator discussed above. In the depicted example, the reachable set R can be visualized as a rectangle, which is drawn, in FIG. 1, using the solid lines parallel to the x- and y-coordinates, respectively. The rectangle represents the boundaries of the reachable set R which result from minimum and maximum values for the acceleration a₀, which depend on the characteristics of the vehicle (e.g. its mass, the engine power, deceleration by braking, etc.) and the initial values v₀ and x₀.

Herein, the term “feature” is used to denote a geometric representation of an object (e.g. a traffic sign, a center line of a road, etc.) that is subject to a rule that may be included in a textual specification. That is, a feature represents the specific interpretation of a generic rule in a specific situation. To give an example related to an automotive application, the generic rule may be “vehicle must not cross a solid line”. In a specific traffic situation, a solid line may be detected (e.g. by the use of sensors) and interpreted as a feature, that adds a further constraint with respect to the movement of the vehicle or, in general terms a further constraint with regard to the system state.

As mentioned, a feature represents a specific manifestation of a generic rule in a specific situation. Thus, a feature divides the reachable set into an “allowed subset” and a “not allowed subset” of the reachable set. While the reachable set defines the set of system states that can theoretically be reached by the system in view of the laws of physics, the allowed subset defines the set of system states that the system can reach without violating the rule, which is represented by the feature in a specific situation. For example, assuming physics allows a vehicle to move forward by 200 meters within the next ten seconds, whereas a stop sign indicating an obligatory stop in 100 meters, the feature representing the stop sign divides the reachable set, which covers a position 200 meters ahead of the vehicle, into an allowed subset, which covers the area in front of the stop sign, and a not allowed subset, which covers the area beyond the stop sign. The stop sign (at a specific position) is a specific manifestation of the generic rule “you must stop at a stop sign” in a specific traffic situation, and this specific manifestation is represented by a feature.

A feature may be represented by a mathematical function (e.g. straight line, a spline, a circle, etc.), and the function may be defined by one or more parameters (also referred to as coefficients) of the function (e.g., in case of a circle by the center point and the radius) and/or a set of points describing the function. FIG. 1 illustrates a feature F as a dashed straight line crossing the reachable set R and dividing it into an allowed subset (white portion of reachable set) and a not allowed subset (shaded portion of the reachable set). A direction indicator I may be associated with a feature to define the direction in which the feature is violated or not violated. In the example of FIG. 1, the direction indicator points towards that portion of the reachable set where the feature is not violated. In other words, the feature divides the allowable set into the allowed subset and the not allowed subset and the direction indicator allows to distinguish the allowed and the not allowed subset. Geometrically the direction indicator can be interpreted as a pointer indicating the direction (with respect to the feature) in which the allowed reachable subset is situated. To summarize the above, the feature F is a specific geometrical/mathematical representation of a specific manifestation (e.g. detected by measurements) of a generic rule, with which the system must comply, in a specific situation. The generic rule may be part of a textual specification of rules/requirements applicable to the system.

As indicated above, one example of a controlled dynamic system is an AV (autonomous vehicle) such as a self-driving car (robotic car), which us used as an example for the further discussion. The above-mentioned textual specification may represent a set of rules with which the system behavior must comply. As a simple example, a traffic rule is considered which states “A solid center line must not be crossed by a car”. Assuming right-hand traffic, if a car drives on the right side of the road, the geometric interpretation of the solid center line can be a feature similar to the feature shown in FIG. 1, wherein the direction indicator points to the side where the vehicle is allowed to drive, while the opposite side is the not allowed subset (the left side of the road in the present example), where the car is not allowed to drive. This simple example illustrates how textual specification (a rule or a set of rules) can be linked to the technical implementation of the system controller. The union of allowed subset and the not allowed set yields the total reachable set; and the allowed subset can be obtained by determining the reachable set and subtracting the not allowed subset which is defined by the features, which are geometric representations of specific manifestations of rules included in a textual specification (rule set). It is understood that the reachable set, the features and the resulting allowed subset are not static but change over time.

Having discussed examples of dynamic systems, a reachable set of system states of the dynamic system and features dividing the reachable set into an allowed subset and a not allowed subset, the following discussion relates to the assessment as to whether a sample system state or a specific system input (resulting in the sample system state) complies with the textual specification represented by the feature(s). This can be accomplished by assessing whether the considered sample state of the system is within the allowed subset or not. In the example of FIG. 1 “Sample 1” represents a sample state within the allowed subset of the reachable set R and “Sample 2” represents a sample states within the not allowed subset. Accordingly, the system state “Sample 1” does not violate the feature F and thus complies with the rule represented by the feature, whereas “Sample 2” does violate the feature F and thus does not comply with the rule. It is noted that the reachable set R shown in FIG. 1 is a 2D object, and may thus be regarded as reachable set of reachable positions (x- and y-coordinates) of a land vehicle. When also considering the velocities (in x- and y-direction) the system state may be regarded as a four-dimensional vector, and the corresponding reachable set may be represented by a 4D object. In such an example, a feature—i.e. the mathematical representation (e.g. a straight line) of a specific manifestation (e.g. halt at red traffic light detected 100 m ahead) of a generic rule (e.g. halt at red traffic light)—may be a 3D hyperplane dividing the 4D reachable set into an allowed subset and a not allowed subset. When, a specific feature is only relevant to the system states representing the velocity (e.g. a 30 km/h speed limit road sign), the allowable set may be reduced to a 2D set and the feature may by represented by a straight line (e.g. at v_{y}=30 km/h when the vehicle is driving in y-direction). This example should also make clear that a feature represents a set of critical system states and thus a boundary of the allowed set.

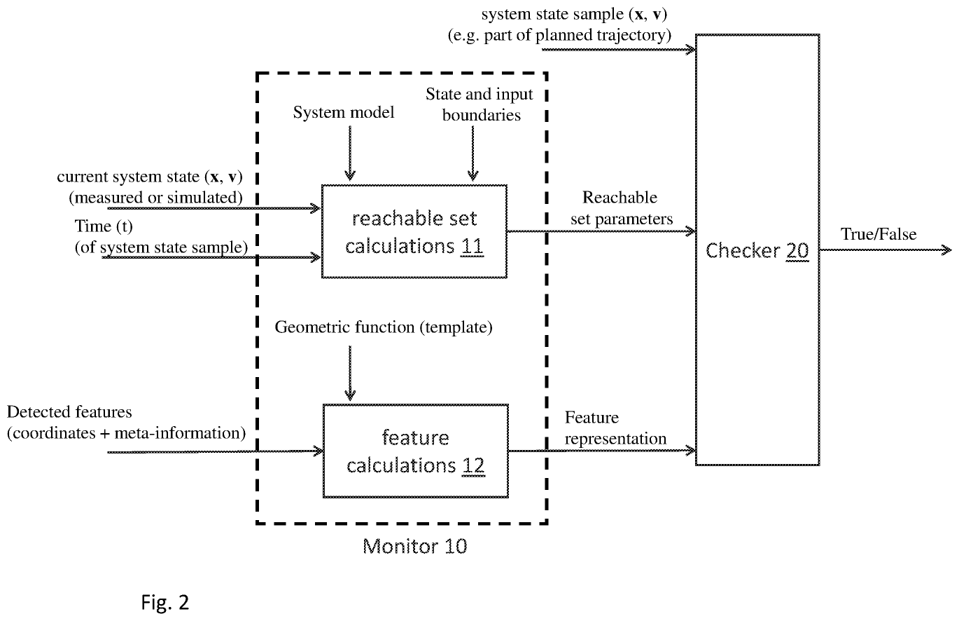

In order to apply a method according to the concepts described above to a real-world system, the method may be implemented digitally using software instructions. When executed on one or more processors, the program including the software instructions perform the required calculations (see FIG. 2, reachable set calculation 11 and feature calculation 12). In accordance with one embodiment the calculations required to determine the reachable set and the calculations required to obtain the features are combined into a software program further referred to as “monitor” 10, while the calculations required to assess, whether a specific sample state is within the allowable subset, are implemented as software program herein referred to as “checker” 20. FIG. 2 illustrates the data flow for one embodiment, where the box drawn with the dashed line represents the monitor 10.

The reachable set calculation 11 requires—as configuration parameters—the system model (e.g. the 2D double integrator mentioned above), the state and input boundaries of the system, and—as input parameters—the current system state (set of system state variables) and a time t, for which the reachable set is to be calculated. The reachable set calculation 11 provides (as output) the parameter values which define the reachable set. These can be the minimum and maximum values of the reachable set (cf. FIG. 1), look up tables or equivalent structures. The calculation of the reachable set can be done using forward or backward reachability analysis. For some system models an analytical solution exists, while some other system models require numerical solutions.

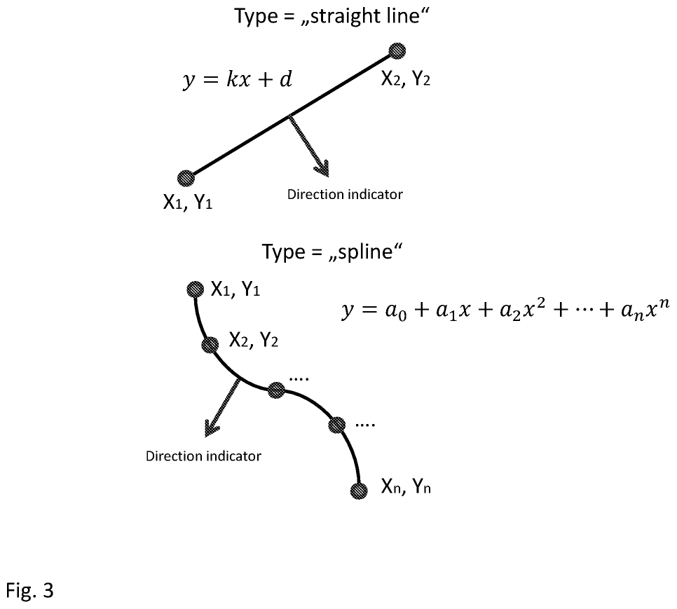

The feature calculation 12 requires as—configuration parameters—the function template (denoted as “geometric function” in FIG. 2) which is to be used to describe the feature. For example, suitable functions maybe be straight lines, splines, circles, et., and combinations thereof. A function can be expressed in different ways. FIG. 3 illustrates, by way of example, how a straight line and a spline can be represented using points (see FIG. 3, points (x₁, y₁) and (x₂, y₂) defining a line) or as a specific formula (see FIG. 3, formula y=a₀+a₁x+a₂x²+ . . . +aₙxⁿ defining a polynomial or spline segment). Depending on the implementation of the checker, the feature calculation may use one representation or another, wherein different representations may be converted from one to another. Furthermore, the function template used for a specific feature may depend on meta-information describing the type of the currently processed feature.

The feature calculation 12 receives—as input—information concerning actually detected (measured) objects such as traffic signs, road markings, etc., in the case of a land vehicle. Detected objects may be represented by their position (i.e. coordinates), their velocity, and meta-information. The meta-information includes information concerning the type of the object and its meaning. The meta-information may represent, for example, “road marking, solid line”, “traffic sign, stop”, “traffic sign, 30 km/h max. speed”, “Traffic light red”. The meta-information allows to map a specific rule (e.g. derived from a textual specification as mentioned above) to a detected object/feature and thus determines how a feature restricts the reachable set to obtain the allowed subset. For example, a solid line road marking will limit the reachable set in a way that certain positions are excluded from the reachable set to obtain the allowed subset, while a 30 km/h max. speed traffic sign will limit the reachable set in a way that certain velocities (beyond a specific position) are excluded from the reachable set to obtain the allowed subset. The outputs/results of the feature calculation 12 are parameters that represents the detected features in a specific format that can be processed by the checker 20. The output of the feature calculation 12 includes function parameters (e.g. spline coefficients) which define, based on the template, a specific realization of the function, which defines, together with the meta-information, the spatial applicability of an associated rule (i.e. defines which portion of the reachable set needs to be excluded to obtain the allowed subset). The meta-information may be used to select a specific function template and, as mentioned, the meta-information also allows to map a feature to a specific rule. When the embodiment of FIG. 2 is used in an off-line application, the input to the feature calculation is not provided by sensors but may be statically defined and stored in a file.

The “checker” 20 receives—as inputs—a sample of the system state and/or a system input, the parameters defining/representing the reachable set (calculated by the reachable set calculation 11), and the information (function parameters, meta-information) defining/representing the features (provided by the feature calculation 12). It is noted that all parameters are calculated for the same time t. The assessment whether or not a sample state violates the feature(s) can be accomplished using methods which are as such well known in the field of computer graphics or similar methods. The checker returns a Boolean variable, e.g. “true” in the event that the sample under test does not violate the feature(s), and returns “false” in the event the assessed sample violates a feature. Additionally, the checker may return the currently tested sample and, if applicable, the violated feature(s).

In the following paragraphs, two applications are described, in which the concepts described above method can be applied. According to the first example, the concept described above is incorporated into the system development process to support engineers during the design process of a controller. According to a second example, the concept described above is used to automatically verify trajectories generated by a path planner that may employ artificial intelligence (AI, e. g. a Deep Neural Network—DNN). Thereby, the trajectories are verified in order to comply with a specification (e. g. technical requirements, or laws such as traffic rules, rules of the air, etc.) during real-time operations. The specification may be provided in a textual form and automatically converted to features using as such known methods. The publication WO 2017/202906 A1 (Computer-assisted Design of Mechatronic Systems to Comply with Textual System Description) describes one example of how a textual specification can be automatically converted into a digital form (representing constraints relevant to the system states). As mentioned, the meta-information associated with a detected (measured) object/feature allows to map a specific object/feature to a generic rule relevant to the detected object/feature.

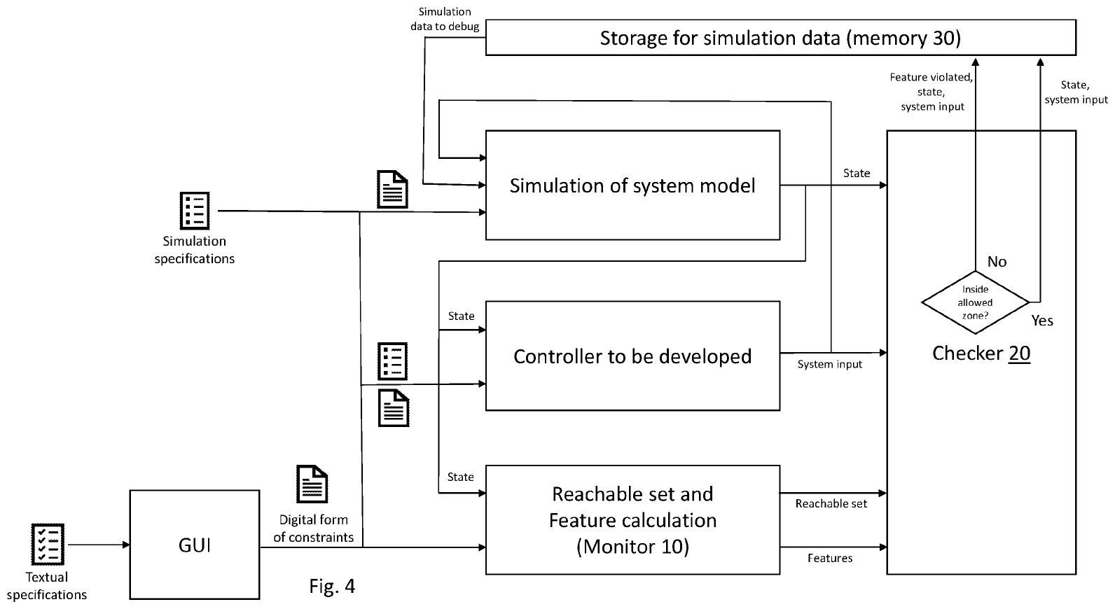

The first application is an offline method as it does not require to satisfy any real-time constraints. FIG. 4 shows one embodiment of the method that is embedded into a development process of a controller (for controlling a dynamic system) in a simulation environment. The method is complemented with a simulation model of the dynamic system to be controlled and other simulation models (as required), a user interface to define, by the user/engineer, objects/features and other simulation parameters according specifications, and a system representing the controller which is to be developed. The objects/features (e.g. traffic signs, road markings, etc.) may be statically defined to simulate a specific traffic situation.

The simulation model of the dynamic system (cf. FIG. 4, “Simulation of System Model”) receives the output of the controller (cf. FIG. 4, “Controller to be developed”) as input. In autonomous driving applications this may be, for example, steering angle, deceleration/acceleration, etc. The output of the simulation model is the system state. In many automotive and aerospace applications the system state may include, for example, position and velocity of a (land or aerial) vehicle. In aerospace applications the position may also include the altitude. The scenario, which is to be simulated, is described in the simulation specifications (see FIG. 3). The configuration parameters of the dynamic system are typically initial state conditions of the system and other parameters (e.g. the mass of the system, maximum acceleration, etc.) used to adapt the simulation model to a specific real world system. The simulation model typically includes a higher-order differential equation which describes the dynamics of the system to be controlled using numerical integration methods. It is noted that simulations models for simulating dynamic systems such as automobiles are as such known and thus not further discussed here. Also known is a great variety of numerical integration algorithms which are commercially available in Software products such as, for example, Matlab/Simulink, which is a de-facto industry standard.

The system model may be complemented with (and thus may include) further simulation models as required. A very common use case is the simulation of other stationary or dynamic objects, sensors or actors, i.e. anything which can affect the behavior of the system model.

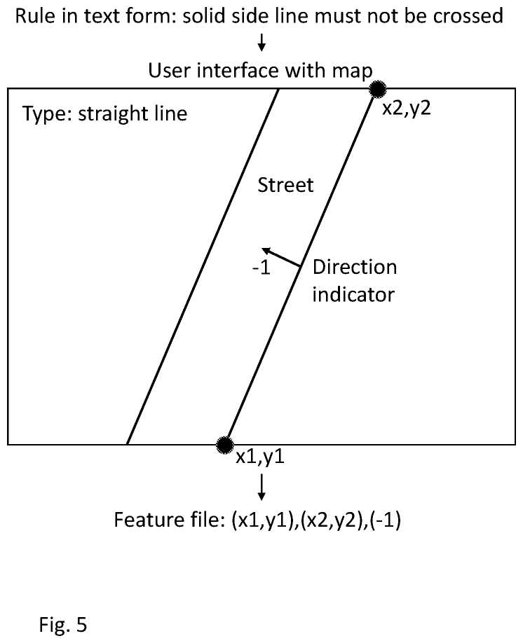

The user interface (see FIG. 4, “GUI”) is used to simplify the process of converting a textual specification of features and/or other simulation parameters into digital form (digital constraints) that can be used by the subsequent simulation models. FIG. 5 illustrates one example (see FIG. 5, “rule in text form”) of how a textual specification (e.g. a rule of a rule set such as “a solid line must not be crossed”) is converted into digital data representing a constraints for the system states (herein also referred to as “digital constraint” or “digital requirement”). If the side line of a road is to be converted into a digital constraint, the first step is to load a digital map representing the road into the user interface. Then the feature (e.g. straight line, spline, etc.) is selected by the user. A computer mouse may be used to select several points, e.g. x₁, y₁ and x₂, y₂ of the side line of the road. The coordinates of all points may be stored into a file. Subsequently, the direction indicator is drawn into the digital map and its value may also be stored (‘−1’ representing the direction, ‘1’ would denote the opposite direction).

Having explained the simulation environment, which is used in the development process, the development process itself is no discussed in more detail. First, the textual specification representing the above-mentioned rule set is written (cf. FIG. 4, “Written specifications”). Using the user interface, the specification is transformed into digital requirements as described above. Then the simulation is developed according the specifications of the simulation environment and the available programming interfaces. After that the controller is designed using any common controller design concepts including, e.g., AI and Deep Neural Networks. To verify, whether the controller design satisfies the textual specifications (converted to digital constraints), the simulated system state and/or the system input are sent to the checker 20, which also receives the calculated reachable set (set of system states that the system can reach) and the calculated features from the monitor 10, which is configured to provide these data (reachable set and features) based on the current system state and the digital constraints as discussed above with reference to FIG. 2, and the statically defined list of objects/features (e.g. virtual traffic signs, virtual road markings, etc.) input via the GUI.

In the checker 20 the system state vector (including system state variables) is tested to verify whether it is inside the allowed reachable set or not. In the event that the system state variables are inside the allowed subset of the reachable set, the next simulation step is performed. In the event that they are not in the allowed subset the simulation is stopped. During each simulation run all simulated states, all system inputs and also the information (state inside/outside allowed subset) obtained from the checker are stored in a digital memory 30 for each simulation step. If the simulation reveals that a feature is violated (corresponding to one specific manifestation of a rule of the textual specification is not complied with), the stored simulation data can then be used by the user/design engineer to redesign the controller in order to avoid situations in which the feature is violated. The stored simulation data may be used to debug the “error” that caused the violation of the feature and to restart the simulation (e.g. with modified controller parameters) at a simulation time before the violation occurred. FIG. 4 summarized this iterative development process, which can be significantly improved in efficiency with the concepts described herein.

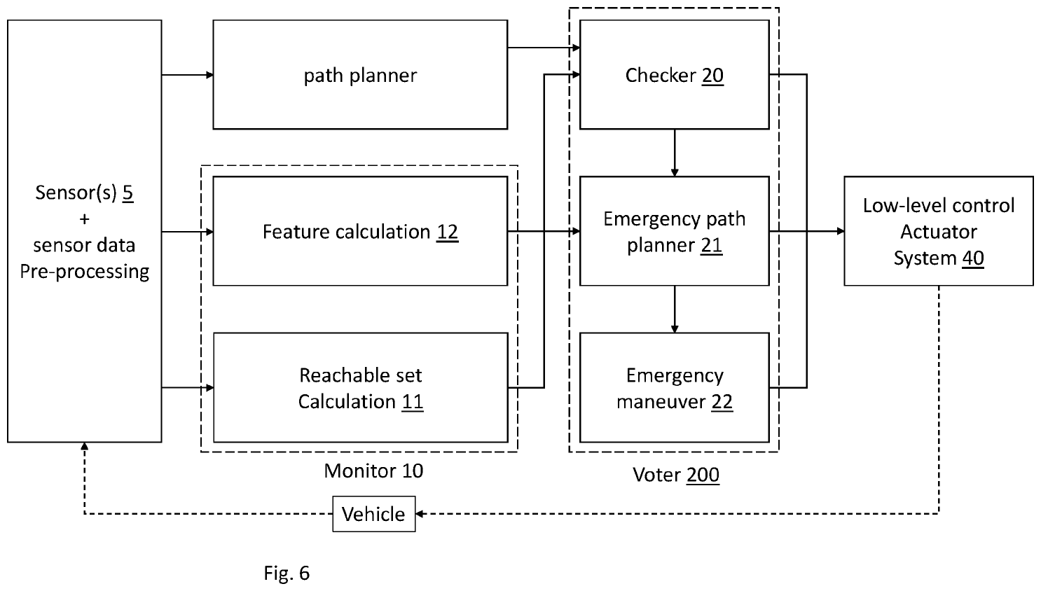

The second application is an online method and therefore must satisfy hard real-time requirements. In this case, the concept of using monitor 10 and checker 20 to test—in real time and during operation of the real-time system—whether a trajectory generated by a controller (in the current example referred to as “path planner” which may include an AI, DNN, etc.) fulfills the textual specification or not. FIG. 6 illustrates the method embedded into a real time application. The concept described above is enhanced by complementing the checker 20 with an emergency path planner 21 and some logic (emergency maneuver controller 22). Checker 20, emergency path planner 21 and emergency maneuver controller 22 are now collectively referred to as “voter” 200. FIG. 6 also shows the system controller which includes a so-called path planner that may be designed using any known techniques. The system controller/path planner may include artificial intelligence, deep neural networks or the like and thus may exhibit a non-deterministic behavior, i.e. a behavior that cannot be predicted/pre-calculated with 100% certainty (dependent on the training of the AI or DNN).

The input to the controller/path planner comes from sensors 5 (including sensor data pre-processing) and the output pf the controller/path planner is provided to the to the actuators 40 of the dynamic system (sensors and actuators may be regarded as part of the dynamic system, e.g. the vehicle, to be controlled). In the example of an autonomous car, the sensors 5 may include, for example, one or more of the following: radar and lidar sensors, cameras, ultrasonic sensors, GPS sensors or the like. Sensor data preprocessing may include any known signal processing technique such as distance and velocity measurement, object recognition, image processing techniques and classification, sensor fusion techniques, etc. The low-level control actuator system 40 substantially includes devices necessary for setting a steering angle and for accelerating/braking the vehicle.

There are two ways how embodiments of the concepts described herein may be integrated into a real-time controlled dynamic system. In one example, only the latest measurements of the sensor(s) is (are) used and applied only in the next simulation step. Another example, works predictive and uses a plurality of (predicted) reachable sets, a plurality of (predicted) features and a plurality of (predicted) system states and/or inputs, which are determined by the path planner. The first example is usually applied to standard feedback controllers while the second example is applied in case of predictive control. It is noted that a planned path determines the desired (predicted) system input and resulting system states for a defined time interval in the future (look-ahead time). As all controllers operate digitally, a system state is a direct result of the system input and the preceding system state(s).

In the following paragraphs only the second example (relating to predictive control) is considered while the first example one is a special case (subfunction) of the second. The common configuration parameters for all subsystems are the sample time T_{S} and the time horizon T_{HORIZON} where T_{HORIZON}=N_{SAMPLE}·T_{S} with N_{SAMPLE} being a positive integer number. The time horizon T_{HORIZON} describes the time span, which the controller looks ahead. A prediction (of reachable sets, features, system states, etc.) is calculated for the discrete times in the vector T_{PREDICT}=[0, T_{S}, 2·T_{S}, 3·T_{S}, . . . , N_{SAMPLE}·T_{S}]. It may have some advantages that all subsystems use the same vector T_{PREDICT}, but this not necessarily a requirement. In the case that any of the subsystems use a different vector T_{PREDICT} a resampling algorithm needs to be applied to synchronize all data.

The main purpose of the path planner (controller) used to control the trajectory of the dynamic system is to generate a trajectory (path) which is collision free, satisfies the textual specifications (e. g. traffic rules, rules of the air), is executable by the dynamic (e.g. the vehicle) and potentially optimizes the passenger comfort. It may use different path planning methods like RRT (Rapidly-exploring random tree), BIT (Batch Informed Trees), Probabilistic Roadmaps, etc. or, as an alternative, a Deep Neural Network. The configuration parameters of the path planner depend on the selected path planning method and the requirements for optimizing the path. The input into the path planner are the current (measured) system states (e.g. position, velocity of the vehicle), environmental sensor measurements (e.g. camera, radar sensors, etc.) and/or features extracted from a sensor preprocessing (e.g. using image processing or object recognition algorithms). The output of the planner is a time vector, a set of sample states and its corresponding system inputs, which together constitute the planned trajectory, which is the desired trajectory of the dynamic system during the near future defined by the time T_{HORIZON}.

In the example of FIG. 6, the monitor receives, as input, either raw real-time sensor readings or feature parameters from the sensor preprocessing calculated in real time. In contrast, in the offline application the monitor receives simulated system states (cf. FIG. 4) and statically defined features (feature parameters). In the case of raw sensor readings, the sensor preprocessing can be included in the monitor. The output of the feature calculation part of the monitor is the set of features. The number of features in the feature set may vary based on the specific scenario/environment, in which the vehicle is used. As mentioned above, the features are calculated predictively for each time instant included in the time vector T_{PREDICT} (representing the look-ahead time). The reachable set calculation part of the monitor uses sensor measurements of the system state and/or the system input as in inputs. The output of the reachable set calculation are the parameters, which describe the reachable set for each time instant included in the time vector T_{PREDICT}. In order to optimize the time needed to calculate all parameters, the calculations can at least partially be done in parallel.

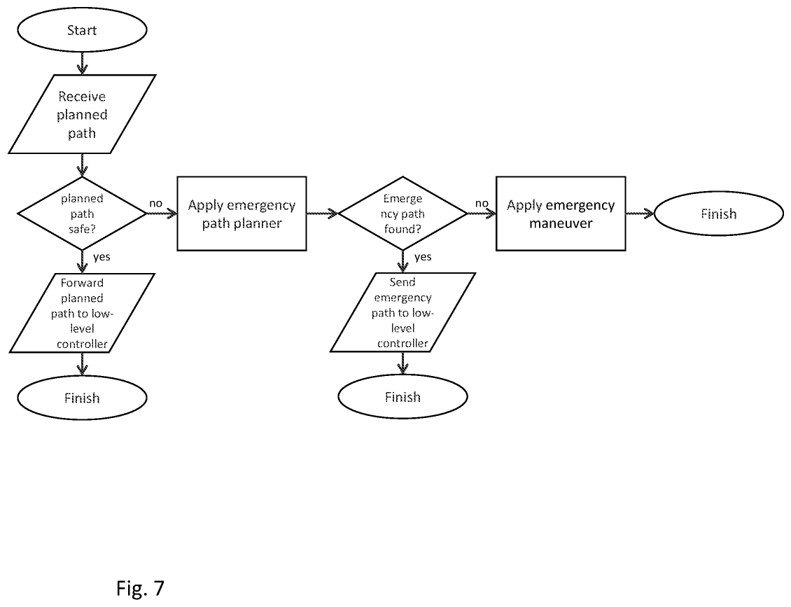

The checker part of the voter is used to assess whether the planned trajectory complies with the textual specification, i.e. whether the predictively planned system states are (for each time instant in the vector T_{PREDICT}) within the allowed subsets of the reachable sets. If the planned trajectory is positively tested (i.e. all requirements are complied with), the planned trajectory is forwarded to the low-level controller of the vehicle, which drives the actuators. If the planned trajectory is negatively tested (i.e. one or more features are violated in at least one time instant of the vector TPREDICT), an emergency path planner included in he voter is used to find an emergency trajectory that brings the vehicle to a predefined safe state which may be, for example, a “full stop” or “follow the vehicle ahead” for a land vehicle or an “emergency landing” for an aerial vehicle. If an emergency path is found, the emergency path is send to the low-level controller of the vehicle. If no emergency trajectory is found, an emergency maneuver may be initiated. For a land vehicle this may be a “full brake” until the vehicle stops, and for an aerial vehicle is could be the initiation of a parachute to bring the aircraft safely to the ground. The above-described example is further illustrated by the flow chart of FIG. 7.

The checker part of the voter functions as described above (cf. FIG. 4 and related description). As, in the present example, a plurality of reachable sets, a plurality of features and a plurality of predicted system states (constituting the planed trajectory) are considered (one for each time instant), the calculations performed by the checker can parallelized. That is, the reachable sets, the features and the system states associated with the same time of the time vector T_{PREDICT} can be processed in parallel. The output of the checker is “true” when the planned trajectory (i.e. the predicted system states that constitute the planned trajectory) is inside the set of allowed reachable sets, and it then sends the nominal path to the low-level controller. When the nominal path is not inside the set of the allowed reachable sets it returns “false”.

In some embodiments, the path planner may output a plurality of trajectories (each composed of a plurality of system states for the time instants included in the vector T_{PREDICT}). In this case, the checker can evaluate the plurality of planned trajectories in order to determine additional parameters, e.g. parameters related to passenger comfort (e.g. maximum acceleration for a specific trajectory). These parameters may be used to evaluate, which trajectory of the plurality of trajectories is the best to be selected and sent to the low-level controller if two or more of the planned trajectories are assessed as safe (i.e. not violating any features).

The emergency path planner may either apply similar path planning methods as the controller/path planner or a more specialized method. The latter may use, for example, lookup tables including one or more pre-calculated paths or use a convex optimization method to find the path to a safe state. To better understand the function of the emergency path planner, a short example is described below. Assuming the system state can be described with four state variables x=[posₓ, pos_{y}, vel, head], wherein posₓ and pos_{y} denote the x- and y-coordinate of a vehicle position, vel denotes the velocity, and ‘head’ the heading of the velocity (which is basically an angle indicating the direction in which the vehicle currently moves). First, a safe state may be defined as “full stop” which can be represented as x=x_{SAFE}=[*, *, 0, *] wherein stands for any value within the allowed reachable sets. It is noted that the plurality of allowed reachable subsets are those allowed subsets (of the reachable sets) calculated for the times in the vector T_{PREDICT}. The first step could be to sample random points in the plurality of allowed reachable subsets, e.g. x=x_{SAMPLE}=[pos_{x,i}, pos_{y,i}, 0, headᵢ]. Then the convex optimization method can be used to find a trajectory from the current (measured) system state x_{current}=[pos_{x,measured}, pos_{y,measured}, vel_{mesasured}, head_{mesaured}] to one of the states x_{SAFE}. In the case an emergency path is found the emergency path planner returns “true” and the planned emergency path is send to low-level controller. In the case no emergency path is found the emergency path planner return “false” and a fall-back emergency maneuver is executed.

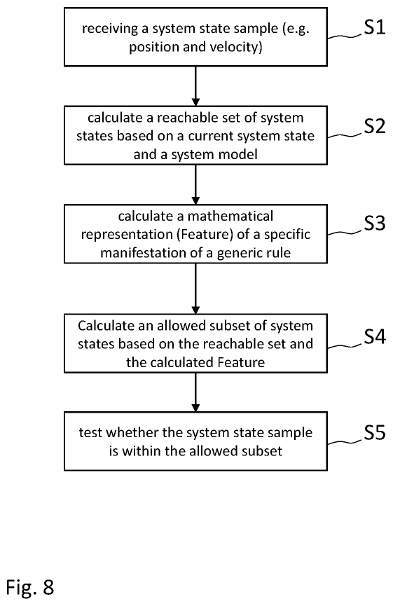

Referring to FIG. 8, several aspects of the concepts described herein are summarized. It is understood that the following is not an exhaustive enumeration but rather an exemplary summary. FIG. 8 describes, by means of a flow chart, a method for supervising a dynamic system, which may be a mechanical system such as a (land or aerial) vehicle. Accordingly, the method includes receiving a system state sample (see FIG. 7, step S1) and calculating, for a specific time instant, a reachable set of system states based on a current system state and a system model representing the dynamic system (see FIG. 7, step S2). The method further includes calculating a mathematical representation of a specific manifestation of a generic rule (see FIG. 7, step S3) and calculating an allowed subset of system states based on the reachable set and the mathematical representation of the specific manifestation of the generic rule (see FIG. 7, step S4). Furthermore, the method includes testing whether the system state sample is within the allowed subset (see FIG. 7, step S5).

The method summarized above with respect to FIG. 8 is in line with the diagram of FIG. 2. The step S2 of calculating a reachable set of system states is performed by the reachable set calculation block/unit 11 (cf. FIG. 2), wherein the calculation is based on the current system state (which may be measured or simulated) and a system model representing the dynamic system. Physical boundaries and constraints of system states (e.g. maximum acceleration, maximum deceleration when braking, maximum steering angle, etc. in the example of a land vehicle) are regarded as part of the system model. The step S3 of calculating a mathematical representation of a specific manifestation of a generic rule is performed by the feature calculation block/unit 12 (cf. FIG. 2). The steps S4 and S5 of calculating the allowed subset of system states and testing whether the system state sample is within the allowed subset are performed by the checker 20 (testing unit/block, cf. FIG. 2).

In one embodiment, the system state sample is calculated—e.g. by a controller/path planner (cf. FIG. 4) and based on a previous system state sample and a system input—in a simulation step of a simulation of the dynamic system to be supervised (offline application). In another embodiment, the system state sample is predicted by a digital controller coupled to the dynamic system, wherein the predicted system state sample is part of a trajectory planned by the controller (online application with, e.g., model predictive control). Therefore, the controller may also be referred to as path planner. It is noted that the system state sample (which is tested in step S5) represents the (planned/predicted) state of the system at the specific time instant (selected from the vector T_{PREDICT} mentioned above), for which the allowable set is calculated.

As explained in detail above, the generic rule defines a general constraint for the state of the system to be supervised. In automotive applications the generic rule may be a traffic rule such as, for example, “halt at crossing upon traffic light showing red”. The rule is generic as it can be applied to all traffic lights showing red. The specific manifestation of the generic rule may be obtained by applying the generic rule to a specific situation, which is detected based on sensor data (online application) or defined by user input (offline application, simulation). The mentioned specific situation will usually be determined by the presence of an object (e.g. a traffic light) in the environment of the system to be supervised. Further developing the current example, once a specific traffic light showing red is detected at the crossing 100 m ahead (e.g. by a camera and image processing installed in an AV), the generic rule “halt at crossing upon traffic light showing red” manifests itself as a specific rule which (when written normal language) may be expressed as “do not drive beyond the crossing 100 m ahead”.

The specific manifestation of the generic rule can be represented by a mathematical function which may interpreted as a geometric structure such as a straight line, a spline, etc. Such a mathematical representation of the specific manifestation of the generic rule defines a boundary of the allowed subset and may thus be used to determine the allowed subset from the reachable set. Accordingly, the allowed subset may be obtained by intersecting the reachable set with the mathematical representation of the specific manifestation of the generic rule, which herein is also referred to as “feature”. In the example of the red traffic light the mathematical representation may be a straight line at y=100 m in a coordinate system moving with the vehicle when the vehicle drives parallel to the y-direction. It is noted that the mathematical representation of the specific manifestation of the generic rule (cf. FIG. 1, feature F) is a mathematical function that represents a set of critical system states. If the constraint defined by the mathematical function is violated, the system state is in the not allowed subset which means that the generic rule is violated.

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated exemplary implementations of the invention.

1-18. (canceled)

19. A method, comprising:
receiving a system state sample;
calculating, for a specific time instant, a reachable set of system states based on a current system state and a system model;
calculating a mathematical representation of a specific manifestation of a generic rule;
calculating an allowed subset of system states based on the reachable set and the mathematical representation of the specific manifestation of the generic rule;
testing whether the system state sample is within the allowed subset; and
indicating whether the system state sample is within the allowed subset.

20. The method of claim 19, wherein the system state sample is calculated, based on a previous system state sample and a system input, in a simulation step of a simulation of the system to be supervised.

21. The method of claim 19, wherein the system state sample is predicted by a controller coupled to the system to be supervised, and wherein the predicted system state sample is part of a trajectory planned by the controller.

22. The method of claim 19, wherein the generic rule defines a general constraint for the state of the system to be supervised.

23. The method of claim 22, wherein the specific manifestation of the generic rule is obtained by applying the generic rule to a specific situation, which is detected based on sensor data or defined by user input.

24. The method of claim 23, wherein a specific situation is determined by a presence of an object in an environment of the system to be supervised, the object being detected based on sensor data or defined by user input.

25. The method of claim 19, wherein the mathematical representation of the specific manifestation of the generic rule defines a boundary of the allowed subset, and wherein the allowed subset is obtained by intersecting the reachable set with the mathematical representation of the specific manifestation of the generic rule.

26. The method of claim 19, wherein the mathematical representation of the specific manifestation of the generic rule is a mathematical function that represents a set of critical system states.

27. The method of claim 19, wherein the system state sample represents the state of the system to be supervised at the specific time instant.

28. The method of claim 27, wherein the system to be supervised is a vehicle, and wherein the system sample state represents position and velocity of the vehicle at the specific time instant.

29. The method of claim 28, wherein the generic rule is a traffic rule.

30. The method of claim 29, wherein the traffic rule links a condition concerning the state of the vehicle to an object present in the environment of the vehicle.

31. The method of claim 30, wherein the specific manifestation of the traffic rule is a specific constraint for the state of the vehicle, the constraint depending on a position of the object in the environment of the vehicle.

32. The method of claim 27, wherein the system to be supervised is a vehicle, and wherein the system sample state includes position, velocity and Euler angles of the vehicle at the specific time instant.

33. The method of claim 32, wherein the generic rule is a traffic rule.

34. The method of claim 33, wherein the traffic rule links a condition concerning the state of the vehicle to an object present in the environment of the vehicle.

35. The method of claim 34, wherein the specific manifestation of the traffic rule is a specific constraint for the state of the vehicle, the constraint depending on a position of the object in the environment of the vehicle.

36. A control system, comprising:
a dynamic system;
a digital controller coupled to the dynamic system to form a control loop;
a monitor unit configured to:
receive sensor data representing information concerning the current system state of the dynamic system;
calculate, for a specific time instant, a reachable set of system states based on the current system state and a system model;
calculate a mathematical representation of a specific manifestation of a generic rule, the specific manifestation being determined based on the sensor data; and
calculate an allowed subset of system states based on the reachable set and the mathematical representation of the specific manifestation of the generic rule;
a testing unit configured to:
receive a system state sample from the digital controller; and
test whether the system state sample is within the allowed subset.

37. The control system of claim 36, wherein the dynamic system is a first mathematical model simulated using a computer running a simulation software, wherein the digital controller is a second mathematical model simulated using a computer running a simulation software, and wherein the sensor data is based on user input.

38. The control system of claim 36, wherein the dynamic system is a vehicle, wherein the control system further comprises an actuator control system configured to generate input signals for actuators driving the dynamic system based on a sequence of system state samples provided by the digital controller, and wherein the testing unit is configured to replace a specific system state sample of the sequence of system state samples by another system state sample if the system state sample is not within the allowed subset.

39. A computer program product comprising a non-transitory computer readable medium storing a computer program, the computer program comprising:
program instructions to receive a system state sample;
program instructions to calculate, for a specific time instant, a reachable set of system states based on a current system state and a system model;
program instructions to calculate a mathematical representation of a specific manifestation of a generic rule;
program instructions to calculate an allowed subset of system states based on the reachable set and the mathematical representation of the specific manifestation of the generic rule;
program instructions to test whether the system state sample is within the allowed subset; and
program instructions to indicate whether the system state sample is within the allowed subset.
